(19) United States
(12) Patent Application Publication
(10) Pub. No.: US 2016/0377782 A1
(43) Pub. Date: Dec. 29, 2016

(54) BIREFRINGENT METHODS TO CREATE OPTICAL EFFECTS FOR PHOTOGRAPHY AND VIDEOGRAPHY

(71) Applicant: CORY SALAR HAGUE, ALISO VIEJO, CA (US)

(72) Inventor: CORY SALAR HAGUE, ALISO VIEJO, CA (US)

(21) Appl. No.: 15/173,564

(22) Filed: Jun. 3, 2016

Related U.S. Application Data
(60) Provisional application No. 62/185,580, filed on Jun. 27, 2015.

(51) Int. Cl. G02B 5/30; G02B 7/00; G02B 27/28; H04N 5/225; G02F 1/01

(52) U.S. Cl. CPC G02B 5/3083; H04N 5/2254; G02F 1/0131; G02B 27/286; G02B 7/00

(57) ABSTRACT

The present invention provides a method of using a birefringent assembly to produce optical effects for use in photography and videography comprising: providing the birefringent assembly comprising a housing, at least one birefringent optical element and at least one polarizing optical element wherein the at least one birefringent optical element and the at least one polarizing optical element are contained within the housing; attaching the birefringent assembly to a camera lens attached to a camera; and capturing an image containing desired optical effects using the camera and the birefringent assembly. The present invention also provides the birefringent assembly discussed herein.

### CLAIM OF BENEFIT OF FILING DATE

This application claims the benefit of the filing date of U.S. Provisional Application Ser. No. 62/185,580 titled: “BIREFRINGENT METHODS TO CREATE OPTICAL EFFECTS FOR PHOTOGRAPHY AND VIDEOGRAPHY” filed on Jun. 27, 2015, which is incorporated herein by reference for all purposes.

### FIELD OF INVENTION

The present invention relates to the field of optical filter effects for photography and videography. More specifically, the invention relates to methods of using birefringent assemblies to produce numerous optical effects for use in photography and videography.

### BACKGROUND

Birefringence is an inherent property of many anisotropic crystals, such as calcite and quartz. It can also arise from other factors, such as molecular structural ordering, physical stress, deformation, flow through a restricted conduit, and strain.

Structural birefringence is found in a wide spectrum of anisotropic materials, including biological entities such as chromosomes, muscle fibers, microtubules, liquid crystalline DNA, and hair. Unlike many other forms of birefringence, structural birefringence is often sensitive to refractive index fluctuations or gradients in the surrounding medium. In addition, many synthetic materials also exhibit structural birefringence, including fibers, long-chain polymers, resins, and composites.

Stress and strain birefringence occurs due to external forces and/or deformation acting on materials that are not naturally birefringent. Examples are stretched films and fibers, deformed glass and plastic lenses, and stressed polymer castings.

Flow birefringence occurs when molecular structures are aligned due to induced hydrodynamic forces. Examples of flow birefringence are asymmetric polymers who's molecular structure becomes ordered in the presence of fluid flow. Rod-shaped and plate-like molecules and macromolecular assemblies, such as high molecular weight DNA and detergents, are often utilized as candidates in flow birefringence studies.

The property of birefringence has created a materials measurement tool that is useful in several applications. Polarized light microscopes are used to study birefringence and linear dichroism in materials that have anisotropic molecular structures. Similar methods for imaging linear optical anisotropies are used (i) by engineers to model strain in injection molded plastic parts, (ii) by manufacturers for quality control in textile production, (iii) by forensic scientists in trace material identification, and (iv) by physicians engaged in microstructural analyses of tissues. However, obtaining quantitative information from images observed by a polarizing microscope requires the use of specialized components such as optical wave retarders constructed of high quality uniformly birefringent materials, and highly accurate positioning systems allowing precise reference to sample location.

Two dimensional images of linear birefringence are achieved by measuring the directions of the fast and slow axes (extinction, φ) based on optical modulation. Three-dimensional maps of birefringence and eigenrays are achieved by examining uniaxial crystals at various angles.

All such methods require post-production image processing. Separation of birefringence, extinction and transmittance is achieved by employing incident circular polarization and a sequence of four measurements with linear polarizer settings at 0°, 45°, 90° and 135°. Each step of the birefringence imaging process requires time for the sequential acquisition, analysis and display of each image, eliminating their use as real time processing techniques. Additionally, existing birefringence examination techniques focus on interrogating birefringent materials to determine their structural properties.

### SUMMARY OF INVENTION

The present invention provides real time birefringent filtering of images without the need for the above-mentioned post-production image and video processing. The birefringent filtering of images can be used to provide desired special effects for photography and videography. The present invention modifies light that is reflected from any polarizing object being photographed or captured on video. It does this by first transmitting the light through a birefringent material and then through a polarizing material to create effects that are dependent on the polarization angle and wavelengths of the light. This effect can be actively altered by adjusting the angular orientation of the polarizing material, the type of polarizing material, the type of birefringent material, the thickness of the birefringent material, the orientation of the birefringent crystalline structure with respect to incident light, which include but are not limited to, the rotation of the birefringent material, the tilt of the birefringent material, and the translation of the birefringent material along or about the optical axis, actively altering the temperature of the birefringent material, applying stress to the birefringent material, or applying strain to the birefringent material. The invention provides optical effects by using the birefringent characteristics of the material rather than identifying the structure of the material from its birefringent attributes.

### BRIEF DESCRIPTION OF THE DRAWINGS

FIG. 1 is a side view of an embodiment of a birefringent assembly in accordance to the principles of the present invention;

FIG. 2 is a perspective view of the assembly shown in FIG. 1;

FIG. 3 is a front view of the assembly shown in FIG. 1;

FIG. 4 is a front view of another embodiment of a birefringent assembly in accordance to the principles of the present invention;

FIG. 5 is a perspective view of the assembly shown in FIG. 4;

FIG. 6 is a side view of the assembly shown in FIG. 4;

FIG. 7 is a top view of the assembly shown in FIG. 4;

FIG. 8 is a side view of yet another embodiment of a birefringent assembly in accordance to the principles of the present invention;

FIG. 9 is a perspective view of the assembly shown in FIG. 8;

FIG. 10 is a flowchart of the components of the assembly shown in FIG. 1;

FIG. 11 is a flowchart of the components of the assembly shown in FIG. 8;

FIG. 12 is a flowchart of the components of an embodiment of a birefringent assembly in accordance to the principles of the present invention; and;

FIG. 13 is a flowchart of the components of another embodiment of a birefringent assembly in accordance to the principles of the present invention.

### DETAILED DESCRIPTION OF THE INVENTION

### Definitions:

Birefringent material: a birefringent material or element can be, but is not limited to, any wave retarder, variable wave retarder, polycarbonate, acrylic, glass, crystal, polymer, window or optical flat, lens, liquid medium, film, coating, prism, retroreflector, or beam splitting cube. The birefringent material can be, but is not limited to being, extruded, machined, grinded, or cut for birefringent uniformity or can be, but is not limited to being, stressed, injection molded, heat formed or heat treated for non-uniform birefringence, to introduce less uniform effect, and/or to introduce new or different wavelengths.

Polarizing lens: a polarizing lens or filter can be, but is not limited to, any linear or circular polarizing optical element or polarizing coating. Polarization can be achieved through several methods such, but not limited to as a polarizing lens, liquid crystal, liquid crystal array, film, optical limiter, surface, window, coating, wire grid. The material or surface may be anywhere along the optical path of the birefringent material. The polarizing lens can also be applied directly onto the birefringent material on one or both of the clear apertures to form a single optic.

Motor: any alternating current (AC) or direct current (DC), brushed, brushless, harmonic, piezo, or stepper motor. The motor may be rotational or translational. The motor may be installed into any gear, worm, pulley, or belt transmission system for an alteration of speed, torque and/or force. The motor may also be encoded to be controlled directly in terms of speed or angle.

Camera: Any image capturing device capable of photographs or video, including but not limited to a photographic camera, a video camera, or a combination thereof.

Housing: Enclosure, mount, or any other feature that secures an optical element.

Movement or move: Any rotation, tilt, or translation, along or across the optical pathway, or electronic stimulation of liquid crystals.

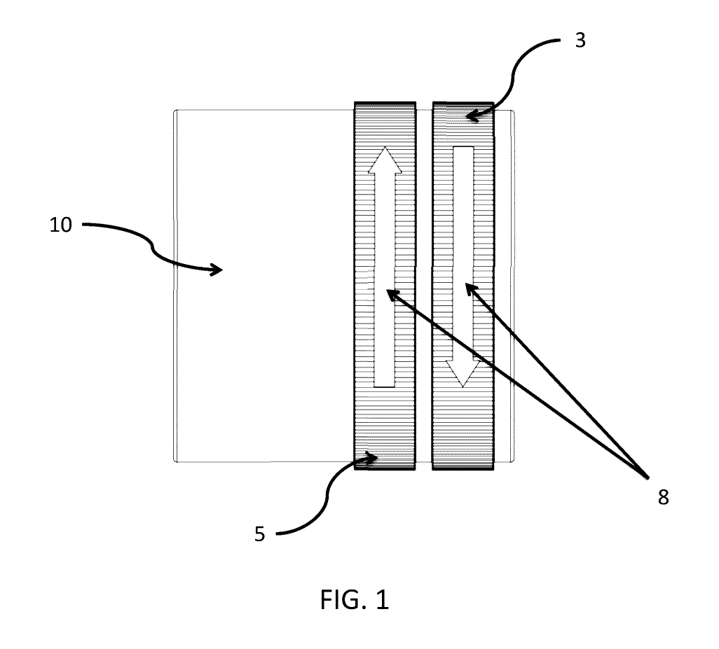

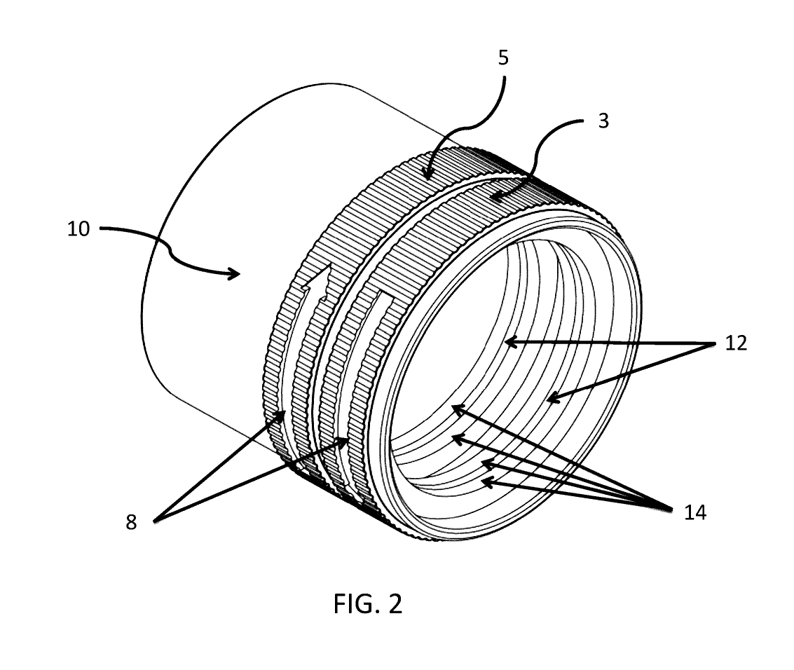

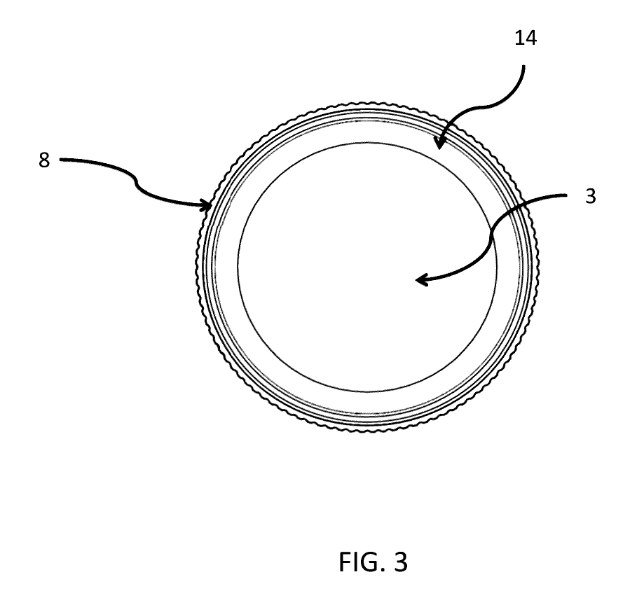

Referring to FIGS. 1-3, the present invention an embodiment of a birefringent assembly 100 in accordance to the principles of the present invention. The birefringent assembly 100 can act as either a photographic lens assembly and/or a video lens assembly in order to produce desired numerous optical effects for use in photography and videography. The birefringent assembly 100 is designed to be placed in front or on top of the lens of a camera (hereinafter collectively referred to as “camera lens”). The assembly 100 includes at least one birefringent optical element 3 and at least one polarizing optical element 5. Both the at least one birefringent optical element 3 and the at least one polarizing optical element 5 are centered along the optical axis of the camera lens. For example, in one embodiment, the assembly includes a polycarbonate window or lens as the at least one birefringent optical element 3 and a polarizing lens as the at least one polarizing optical element 5. The at least one birefringent optical element 3 is placed in proximity to as the at least one polarizing optical element 5. These two optical elements (3, 5) are located along the optical axis of the camera lens. Either or both of these optical elements (3, 5) may also be aligned at an angle to the optical axis of the camera lens. Both of these optical elements (3, 5) are free to independently rotate around the optical axis of the cameras lens. Each of the optical elements (3, 5) includes features 8 (e.g., housing rings, lens mounts, etc.) that facilitate its movement (e.g., rotation, translation, tilt and a combination thereof). For example, the birefringent optical element 3 can be rotated, tilted, and/or translated in three-dimensions in order to produce various visual effects.

The at least one birefringent optical element 3 causes any polarized light that passes through it to be differentiated in refractivity based upon specific wavelengths that are characteristic of the birefringent material and the polarization angle. The transmitted light is then passed through the polarizer light filter that exploits the wavelengths that are a result of cross polarization in reference to the original polarization of the captured light. This results in an optical effect that causes certain emitting polarized angles of light to be selectively colorized while leaving the rest of the image unaltered.

The method of the present invention provides real time birefringent filtering of images without the need for the above-mentioned post-production image and video processing. The birefringent filtering of images can be used to provide desired special effects for photography and videography. The present invention modifies light that is reflected from any polarizing object being photographed or captured on video. It does this by first transmitting the light through the at least one birefringent optical element 3 and then through the at least one polarizing element 5 to create effects that are dependent on the polarization angle and wavelengths of the light. This visual or optical effect can be actively altered by adjusting the angular orientation of the at least one polarizing optical element 5, the type of material of the at least one polarizing optical element 5, the type of material of the at least one birefringent optical element 3, the thickness of the at least one birefringent optical element 3, the orientation of the birefringent crystalline structure with respect to incident light, which include but are not limited to, the rotation, tilt, and/or translation of the at least one birefringent optical element 3 along or about the optical axis. The visual or optical effect can also be actively altered at least in part by various conventional control means such as temperature control means (e.g., conductive coatings such as indium tin oxide, or resistive heater such as a wire, or the like) for altering temperature of material of the at least one birefringent optical element; stress control means for applying stress or strain (e.g., piezoelectric materials, or motors, or electroactive polymers, physical forces applied by a human user, or the like) to the material of the at least one birefringent optical element; birefringent electrical control means (e.g., variable wave retarder or the like) for electrically stimulating material of the at least one birefringent optical element; polarizing electrical control means (e.g., (e.g., liquid crystal or optical limiter or the like) for electrically stimulating material of the at least one polarizing optical element, and a combination thereof.

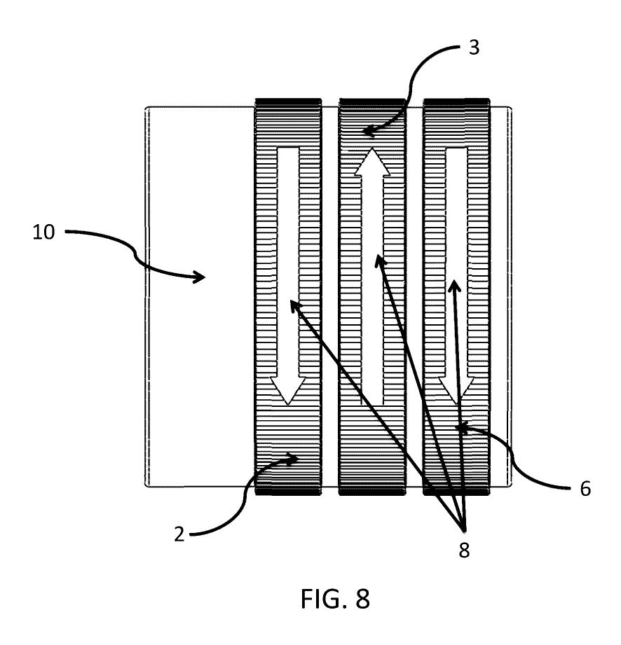

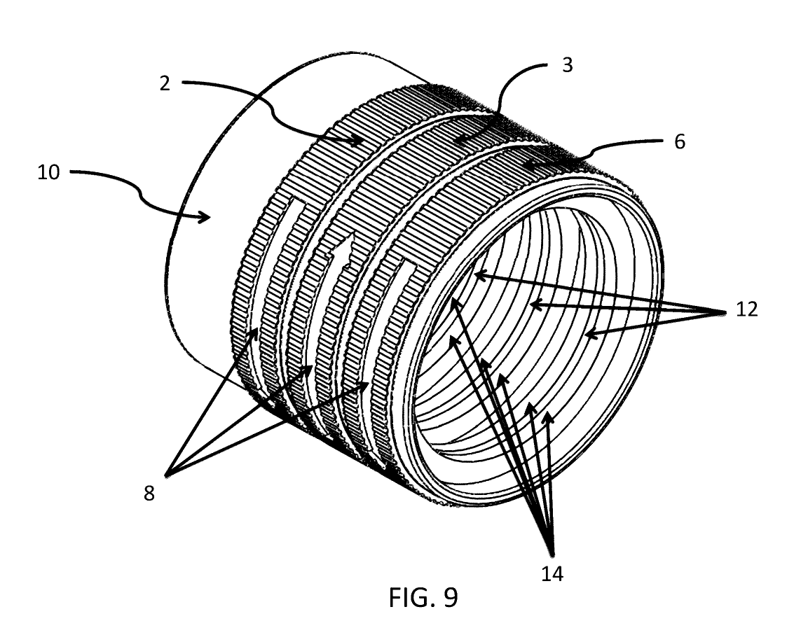

Referring to FIGS. 8-9, another embodiment of the assembly 200 includes three optical elements. The at least one birefringent optical element 3 is a polycarbonate window, and the at least one polarizing optical element 5 are comprised of two polarizing lens (2, 6). Referring to FIG. 1 and as indicated by the directional arrows 8, each of these optical elements can be moved (e.g., rotated) independently of each other in either direction along the optical axis of the camera lens. It should be noted that all of these optical elements of the assembly 200 are optionally centered along one or more axis. The optical elements 3 can be constructed of any suitable birefringent material(s) based upon the desired effect(s).

Referring to FIGS. 1-3 and 8-9, the assembly 100 and 200 further includes a housing 10 that contains the at least one birefringent optical element 3 and the at least one polarizing optical element 5 (2, 6). The housing 10 is constructed of a suitable material such as plastic, aluminum or steel. Each of the optical elements (3, 5, 2, 6) are located within a groove 12 of the housing and secured by an inner lip 14 of the housing 10. This arrangement allows the independent manual movement (e.g., rotation) of each optical element (3, 5, 2, 6) to provide numerous and varied combinations of polarization and birefringence.

Referring to FIGS. 8-9, in this embodiment, the polarizing lens 6 blocks the incoming light that is not at the same polarization angle as the polarizing lens 6's construction allows. The polarized light is then passed through the at least one birefringent optical element 3. This optical element 3 may be composed of any suitable anisotropic material such as, but not limited to, polycarbonate or wave retarder. The optical transmission properties of the material in the at least one birefringent optical element 3 cause the polarized light to refract at different angles which are dependent on the wavelengths of the light. The filtered light is then passed to the second polarizing lens 2. The polarization angle may be changed by rotating the optical elements (2, 3, 6) independently, thereby changing the relationship between the polarized light and the birefringent separation of the different frequencies of light. The interdependency between polarization and birefringence results in optical effects relating color to polarization angle.

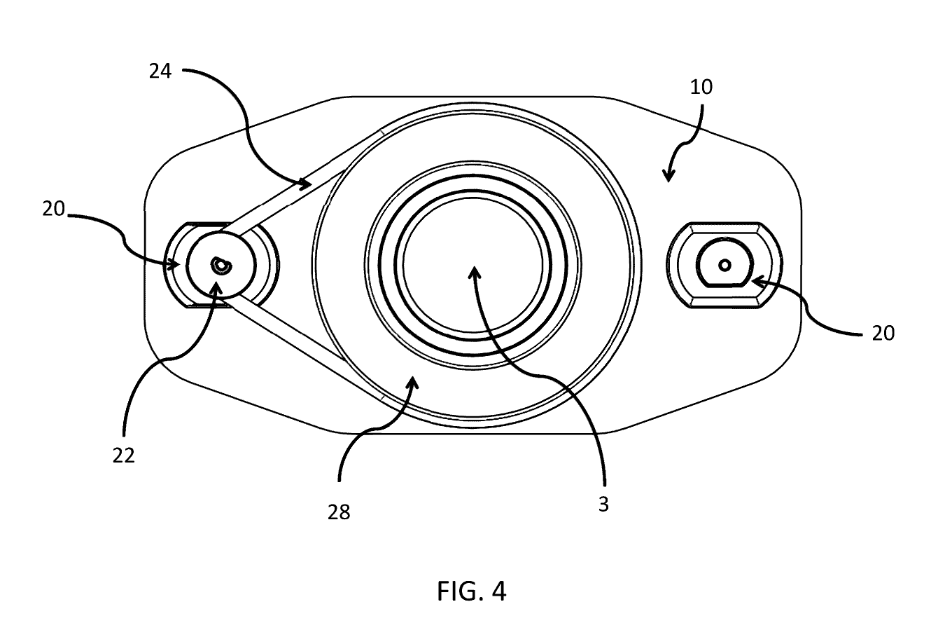

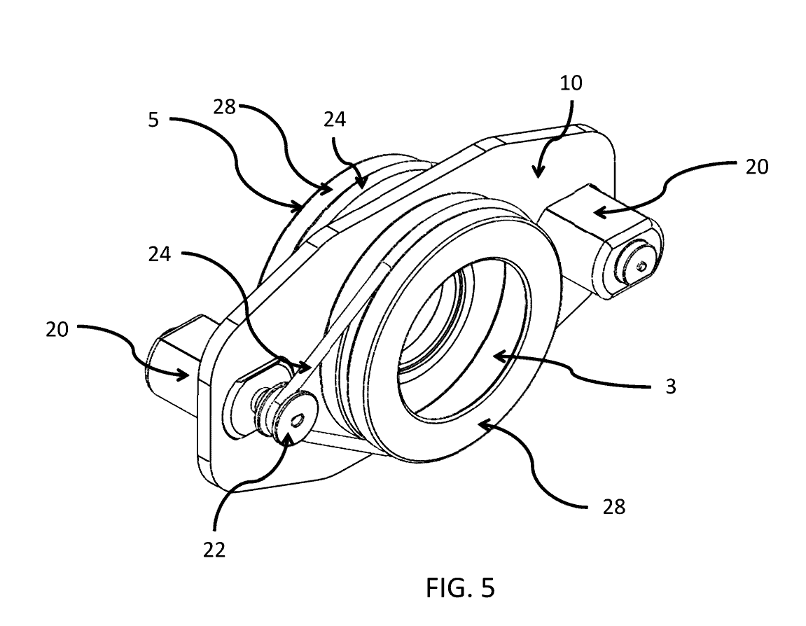

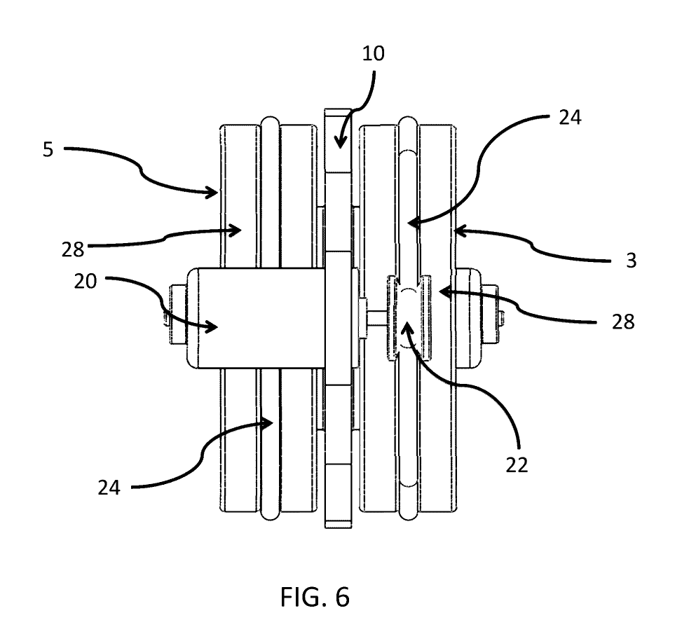

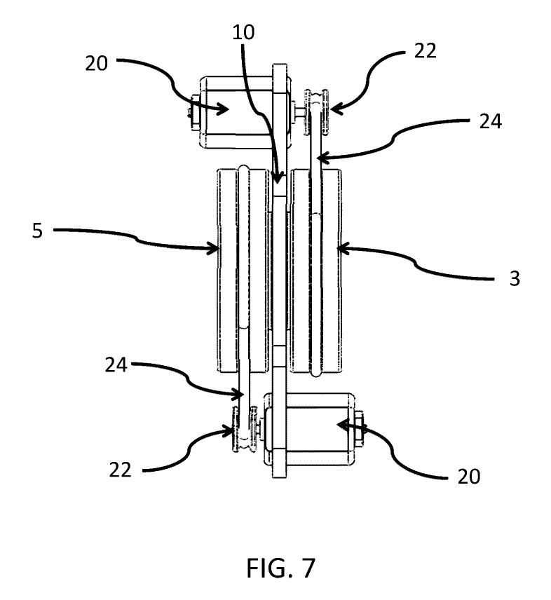

Referring to FIGS. 4-7, another embodiment 300 of the birefringent assembly of the present invention is presented. This embodiment 300 serves the same purpose and provides the same functions as discussed above for the birefringent assembly 100 and 200. Moreover, the birefringent assembly 300 also contains the same optical elements (3, 5) as the birefringent assembly 100. Both the at least one birefringent optical element 3 and the at least one polarizing optical element 5 are also centered along the optical axis of the camera lens. The major difference between the birefringent assembly 300 and the birefringent assembly 100 and 200 is that the birefringent assembly 300 provides motorization for rotating the optical elements (3, 5). The motorization can rotate each of the optical elements (3, 5) independently or together.

In the birefringent assembly 300, two motors 20 are placed at opposite locations normal to the optical axis of the camera lens. Any suitable motors can be used such as but is not limited to, direct current (DC), alternating current (AC), brushed, piezo, brushless, servo, encoded, stepper, or any other type or design appropriate for controlled bidirectional or unidirectional movement (e.g., rotation), and a combination thereof. The motors 20 are used to rotate the optical elements (3, 5). In one embodiment, the alignment of the motors 20 is opposite with one motor 20 facing directly towards the camera lens (not shown) and the other motor 20 facing away from the camera lens. Although the motors 20 are facing towards and away from the camera lens both motors 20 are aligned along the same axis as the optical elements (3, 5) they (20) are respectively attached to. It should be noted that the locations of the motors 20 are not limited to this configuration. One skilled in the art can use an alternative configuration. The motors 20 basically can be located in any suitable locations within the birefringent assembly 300 as long as they can be used to move (e.g., rotate) the optical elements (3, 5).

Each of the motors 20 is part of a motor assembly that includes a motor control system (not shown), a motor drive mechanism 22, an element drive transfer mechanism 24, and a bearing mount 28. The motors 20 are controlled by the motor control system, which allows direction, speed, tilt, translation, and/or position control. The motors 20 are held in position by the housing 10 to which the motors 20 are attached by any suitable conventional means used in applications as robotics and/or automation. Each of the motors 20 is connected to the motor drive mechanism 22, which may be a pulley, gear, or bevel which allows the rotational motion of the motor shaft to be transferred to the at least one polarizing optical element 5 and/or the at least one birefringent optical element 3 via the element drive transfer mechanism 24, which may be a chain, belt or band, timing belt or any of several means currently used in such applications as robotics and automation. The polarizing element 5 and the birefringent element 3 are each attached to the element drive mechanism 24. The element drive mechanism 24 is attached to the bearing mount 28 that holds its respective optical element (3, 5). The bearing mount 28 reduces friction generated by the rotation of the optical element (3, 5) thereby allowing precise speed and positional control. The bearing mount 28 is linked to the motor drive mechanism 22 by the element drive mechanism 24.

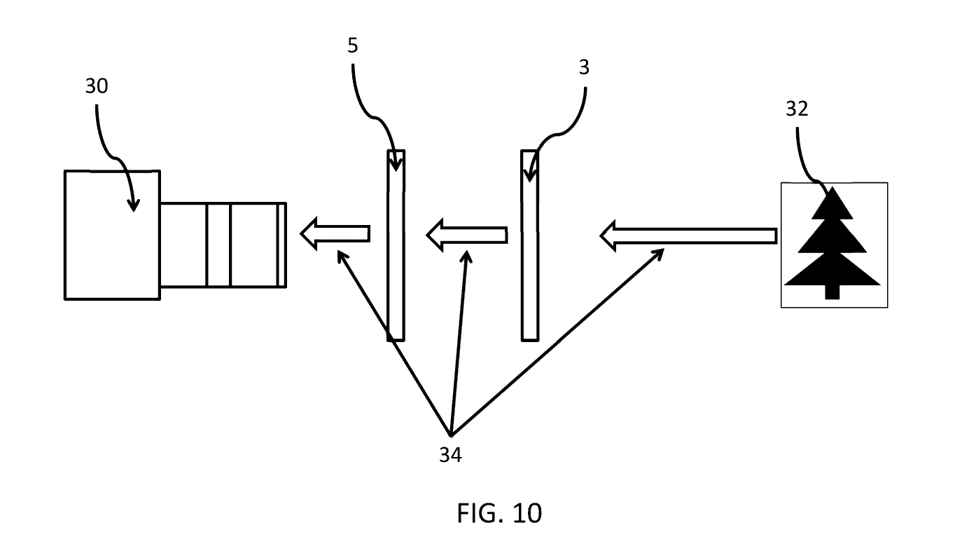

Referring to FIG. 10, the assembly 100 is described in a conceptual flow chart showing the optical pathway 34 from a scene 32 to the camera lens 30 via first the birefringent optical element 3 of the assembly 100 and then the polarizing optical element 5 of the assembly 100. Basically, light from the scene 32 is traversing along the optical pathway 34 first through the birefringent optical element 3, then through the polarizing optical element 5, before it is transmitted onto the camera lens 30. The assembly 100 has a greater effect on polarized light.

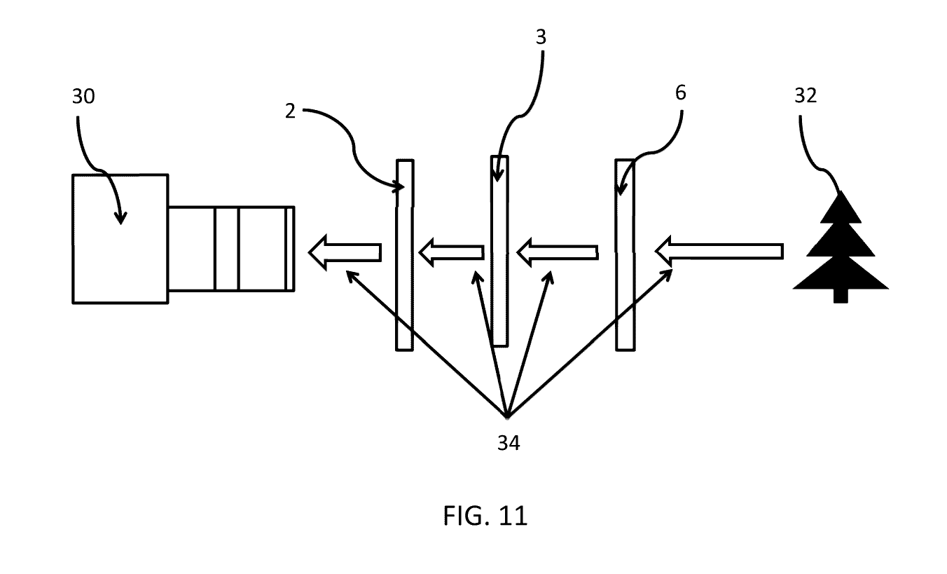

Referring to FIG. 11, the assembly 200 is described in a conceptual flow chart showing the optical pathway 34 from a scene 32 to the camera lens 30 via first the polarizing optical element 6, the birefringent optical element 3, and then the polarizing optical element 2. Basically, light from the scene 32 is traversing along the optical pathway 34 first through the polarizing optical element 6, the birefringent optical element 3, then through the polarizing optical element 2, before it gets transmitted onto the camera lens 30. This allows for the effect to be applied to any transmitted light from the scene including non-polarized light.

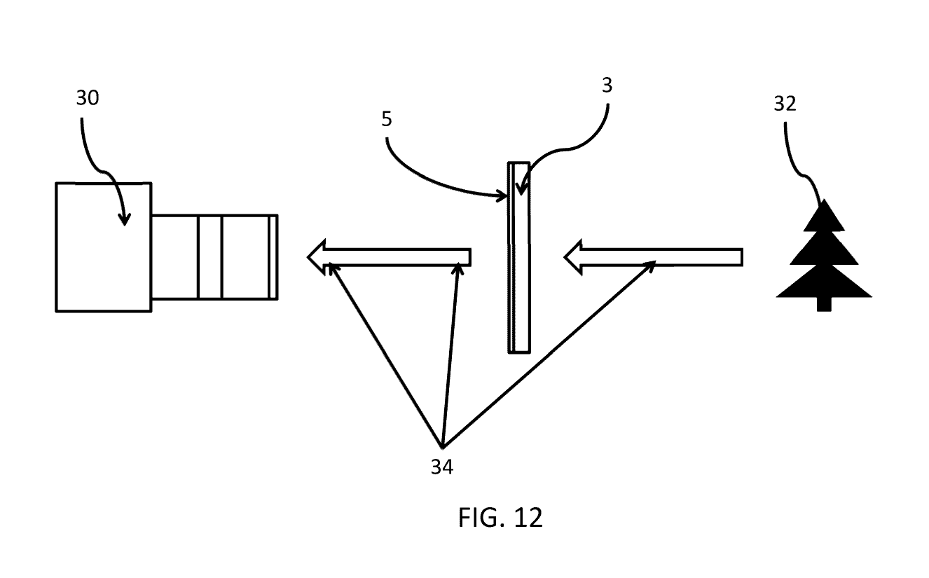

Referring to FIG. 12, the assembly 100 is described in a conceptual flow chart showing the optical pathway 34 from a scene 32 to the camera lens 30 via first the birefringent optical element 3 of the assembly 100 and then the polarizing optical element 5 of the assembly 100. In this embodiment, the polarizing optical element 5 is actually a coating applied to the transmissive clear aperture of the birefringent optical element 3. This embodiment allows the two optical elements (3, 5) to be constructed as a single component.

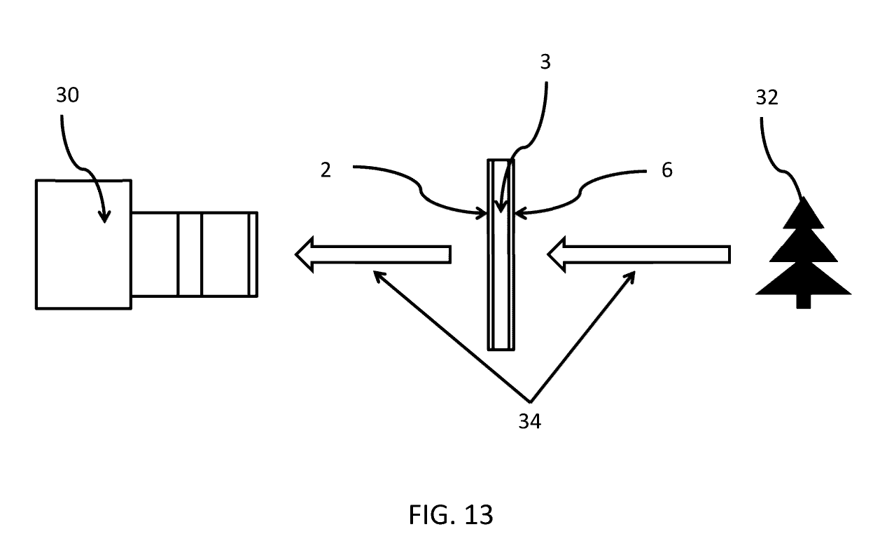

Referring to FIG. 13, the assembly 200 is described in a conceptual flow chart showing the optical pathway 34 from a scene 32 to the camera lens 30 via first the polarizing optical element 6, the birefringent optical element 3, and then the polarizing optical element 2. In this embodiment, the polarizing optical elements (6, 2) are actually coatings applied to opposite sides (incident and transmissive clear apertures) of the birefringent optical element 3. This embodiment allows the three optical elements (2, 3, 6) to be constructed as a single component.

It should be noted that the present invention may consist of one or more polarizing optical elements and one or more birefringent optical elements in varied sequences in order to provide produce desired effects.

The embodiments shown herein are by way of example and for purposes of illustrative discussion of the invention only and are presented in the cause of providing what is believed to be the most useful and readily understood description of the principles and conceptual aspects of the invention. In this regard, no attempt is made to show structural details of the invention in more detail than is necessary for the fundamental understanding of the invention, the description taken with the drawings making apparent to those skilled in the art how the several forms of the invention may be embodied in practice. It is understood that the present invention as described and claimed herein can be used for many additional purposes, therefore the invention is within the scope of other fields and uses and not so limited. The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. A method of using a birefringent assembly to produce optical effects for use in photography and videography comprising:
(a) providing the birefringent assembly comprising of at least one birefringent optical element and at least one polarizing optical element.
(b) attaching the birefringent assembly to a camera lens attached to a camera; and
(c) capturing an image containing desired optical effects using the camera and the birefringent assembly.

2. The method of claim 1 wherein the desired optical effects are produced at least in part by a method selected from the group consisting of altering temperature of material of the at least one birefringent optical element, applying stress or strain to the material of the at least one birefringent optical element, electrically stimulating material of the at least one birefringent optical element, electrically stimulating material of the at least one polarizing optical element, and a combination thereof.

3. The method of claim 1 wherein (a) the birefringent assembly is placed in front of or on top of lens of a camera; (b) both the at least one birefringent optical element and the at least one polarizing optical element are centered along optical axis of the lens of the camera; (c) the at least one birefringent optical element and the at least one polarizing optical element are free to independently rotate around the optical axis of the lens of the camera.

4. The method of claim 3 wherein (a) light traverses along an optical pathway first through the at least birefringent optical element, then through the at least one polarizing optical element, before being transmitted onto the lens of the camera; (b) the at least one birefringent optical element causes light that passes through the at least one birefringent optical element to be differentiated in refractivity based upon specific wavelengths that are characteristic of the at least one birefringent material and polarization angle, and the light is then passed through the at least one polarizing optical element resulting in an optical effect that causes certain emitting polarized angles of light to be selectively colorized while leaving remaining portions of an captured image unaltered.

5. The method of claim 3 wherein light traverses along an optical pathway first through one of the at least one polarizing optical element, then through the at least birefringent optical element, and subsequently through another one of the at least one polarizing optical element, before being transmitted onto the lens of the camera.

6. A birefringent assembly for producing optical effects for use in photography and videography comprising: a housing, at least one birefringent optical element and at least one polarizing optical element wherein the at least one birefringent optical element and the at least one polarizing optical element are contained within the housing.

7. The assembly of claim 6 wherein the at least one polarizing optical element is a coating applied to transmissive clear aperture of the at least one birefringent optical element.

8. The assembly of claim 6 wherein the at least one polarizing optical element is comprised of a coating applied to transmissive clear aperture of the at least one birefringent optical element; and another coating applied to incident clear aperture of the at least one birefringent optical element.

9. The assembly of claim 6 wherein (a) the birefringent assembly is designed to be placed in front of or on top of lens of a camera; (b) both the at least one birefringent optical element and the at least one polarizing optical element are centered along optical axis of the lens of the camera; (c) the optical effects are produced at least in part by control means selected from the group consisting of: temperature control means for altering temperature of material of the at least one birefringent optical element, stress control means for applying stress or strain to the material of the at least one birefringent optical element, birefringent electrical control means for electrically stimulating material of the at least one birefringent optical element, polarizing electrical control means for electrically stimulating material of the at least one polarizing optical element, and a combination thereof.

10. The assembly of claim 6 wherein (a) the birefringent assembly is designed to be placed in front of or on top of lens of a camera; (b) both the at least one birefringent optical element and the at least one polarizing optical element are centered along optical axis of the lens of the camera; (c) the at least one birefringent optical element includes at least one movement feature in order to allow the at least one birefringent optical element to independently move around the optical axis of the lens of the camera; (d) the at least one polarizing optical element includes at least one movement feature in order to allow the at least one polarizing optical element to independently move around the optical axis of the lens of the camera.

11. The assembly of claim 10 wherein (a) the at least one movement feature of the at least one birefringent optical element is a groove within the housing having an inner lip that secures the at least one birefringent optical element within the housing; (b) the at least one movement feature allows the at least one birefringent optical element to rotate, tilt, and translated in three-dimensions in order to produce various visual effects; (c) the at least one movement feature of the at least one polarizing optical element is a groove within the housing having an inner lip that secures the at least one polarizing optical element within the housing; and (d) the at least one movement feature allows the at least one polarizing optical element to rotate, tilt, and translated in three-dimensions in order to produce various visual effects.

12. The assembly of claim 10 wherein (a) the at least one birefringent optical element is a polycarbonate window; (b) the at least one polarizing optical element is comprised of two polarizing lens; and (c) the polycarbonate window and each of the two polarizing lens can independently move in either direction along the optical axis of the lens of the camera.

13. The assembly of claim 10 wherein the at least one movement feature of the at least one birefringent optical element and the at least one movement feature for the at least one polarizing optical element further include motors to provide motorized control of movements of the optical elements.

14. The assembly of claim 13 further comprising motor assemblies wherein each motor assembly is comprised of a motor, a motor control system, a motor drive mechanism, an element drive transfer mechanism, and a bearing mount wherein (a) the motor is held in position by the housing; (b) the motor is connected to the motor drive mechanism; (c) the motor drive mechanism is connected to the element drive mechanism via the bearing mount; (d) the bearing mount holds the at least one polarizing optical element or the at least one birefringent optical element; (f) the motor drive mechanism and the elemental drive transfer mechanism allow rotational motion of shaft of the motor to be transferred to either the at least one polarizing optical element or the at least one birefringent optical element held by the bearing mount.

15. The assembly of claim 13 wherein the motors are aligned along same axis as the at least one birefringent optical element and the at least one polarizing optical element with one of the motors facing directly towards the lens of the camera while the other one of the motors facing away from the lens the camera.

16. A birefringent assembly for producing optical effects for use in photography and videography comprising: a housing, at least one birefringent optical element and at least one polarizing optical element wherein: (a) the at least one birefringent optical element and the at least one polarizing optical element are contained within the housing; and (b) the at least one birefringent optical element this is capable of movement, the at least one polarizing optical element that is capable of movement, or both the at least one birefringent optical element and the at least one polarizing optical can be capable of movement.

17. The assembly of claim 16 wherein the at least one polarizing optical element is comprised of a coating applied to transmissive clear aperture of the at least one birefringent optical element; and another coating applied to incident clear aperture of the at least one birefringent optical element.

18. The assembly of claim 16 wherein (a) the birefringent assembly is designed to be placed in front of or on top of lens of a camera; (b) both the at least one birefringent optical element and the at least one polarizing optical element are centered along optical axis of the lens of the camera; (c) movement features assist in providing (i) movement of the at least one birefringent optical element and (ii) movement of the at least one polarizing optical element; the movement features allow the optical elements to independently rotate around the optical axis of the lens of the camera.

19. The assembly of claim 16 wherein the movement features are comprised of a groove within the housing having an inner lip that secures either the at least one birefringent optical element or the at least one polarizing optical element within the housing.

20. The assembly of claim 16 further comprising motor assemblies to provide motorized control of movements of the at least one birefringent optical element and the at least one polarizing optical element wherein each motor assembly is comprised of a motor, a motor control system, a motor drive mechanism, an element drive transfer mechanism, and a bearing mount wherein (a) the motor is held in position by the housing; (b) the motor is connected to the motor drive mechanism; (c) the motor drive mechanism is connected to the element drive mechanism via the bearing mount; (d) the bearing mount holds the at least one polarizing optical element or the at least one birefringent optical element; (0 the motor drive mechanism and the elemental drive transfer mechanism allow rotational motion of shaft of the motor to be transferred to either the at least one polarizing optical element or the at least one birefringent optical element held by the bearing mount.
